(19) United States
(12) Patent Application Publication
(10) Pub. No.: US 2025/0125671 A1
(43) Pub. Date: Apr. 17, 2025

(54) Stator and Electrical Machine

(71) Applicant: FEAAM GmbH, Neubiberg (DE)

(72) Inventor: Gurakuq DAJAKU, Neubiberg (DE)

(73) Assignee: FEAAM GmbH, Neubiberg (DE)

(21) Appl. No.: 18/834,571

(22) PCT Filed: Jan. 31, 2023
(86) PCT No.: PCT/EP2023/052334

§ 371 Date: Jul. 30, 2024

(30) Foreign Application Priority Data
Feb. 1, 2022 (DE) 10 2022 102 313.3

(51) Int. Cl. H02K 1/14; H02K 21/16

(52) U.S. Cl. CPC H02K 1/148; H02K 21/16

(57) ABSTRACT

A stator (1) for an electrical machine comprises a plurality of stator teeth distributed along the circumference of the stator and with slots (2) formed between each of them. Coils of the same electrical phase (U, V, W) are arranged adjacent to each other and wound around respective teeth (3). At least one unwound tooth (4) is provided between the adjacent coils of the same electrical phase. The teeth (3) wound with adjacent coils of the same electrical phase each have a recess (5) which extends substantially in the radial direction and is arranged in the tooth region, or the at least one unwound tooth (4) each has a recess (5) which extends substantially in the radial direction and is arranged in the tooth region.

The present application relates to a stator for an electrical machine and an electrical machine with the stator.

In the last two decades, fractional-slot concentrated windings (FSCWs) have been increasingly used in synchronous machines in numerous applications. The reasons for this are the ease of manufacture and attractive characteristics such as a good power-to-weight ratio, low copper losses, high fault tolerances, non-overlapping coils and short winding heads.

In such machines, the fundamental waves of the magnetomotive force are often not used as the working wave, but a higher harmonic, for example the fifth or seventh harmonic of the magnetomotive force. FSCWs can be designed as a single-layer winding or as a multi-layer winding.

The subject of the present patent application is single-layer winding.

It is desirable to amplify the working wave in relation to the other harmonic components, including the fundamental waves, or to suppress or reduce the undesirable components of the magnetomotive force.

This problem is solved with the objects of the independent patent claims.

Further developments and advantageous embodiments are given in the dependent patent claims.

In one embodiment, a stator for an electrical machine has several stator teeth distributed along the circumference of the stator. Grooves are formed between the stator teeth, whereby coils of the same electrical phase are arranged adjacent to each other and wound around the respective teeth.

This means that at least two coils of the same electrical phase are wound around adjacent teeth, whereby a total of several, for example three, different electrical phases can occur, for example in a three-phase machine. At least one unwound tooth is provided between the neighboring coils of the same electrical phase.

The teeth wound with adjacent coils of the same electrical phase each have a recess which extends substantially in the radial direction and is arranged in the tooth region. In another embodiment, the at least one unwound tooth has a recess which extends substantially in the radial direction and is arranged in the tooth region.

In other words, the recess extending in the radial direction can be provided in the area of the unwound tooth or in the area of the teeth wound with coils of the same phase.

In both cases, the additional recess in the tooth area amplifies the working wave, for example the fifth or seventh harmonic of the magnetomotive force, while other significant harmonic components of the magnetomotive force, in particular the fundamental waves, are significantly reduced.

In the case of the arrangement of the recess in the unwound tooth, which is arranged between teeth with coils of the same phase, in one embodiment a recess can also be provided in an unwound tooth, which is arranged between teeth with coils of different phases.

This reduces the magnetic coupling between the different phases.

In one embodiment, the recess forms a mechanical barrier to reduce the fundamental waves of the magnetic flux.

In one embodiment, the distance between the recesses, measured in the circumferential direction, corresponds exactly to twice the groove spacing. For example, a stator with 12 slots therefore has six recesses in the radial direction.

In one embodiment, a higher harmonic of the magnetomotive force that is different from the fundamental waves is used as the working wave. This can be, for example, the fifth or seventh harmonic, but also other harmonics.

In one embodiment, the stator comprises a multiphase single-layer winding comprising the aforementioned coils, which are inserted in slots and wound around the aforementioned teeth.

In one embodiment, exactly two coils of the same phase are arranged adjacent to each other and wound around teeth of the stator.

In another embodiment, exactly three coils of the same phase are arranged adjacent to each other and wound around teeth of the stator.

In a further embodiment, more than three coils of the same phase are arranged adjacent to each other and wound around teeth of the stator.

In one embodiment, the neighboring coils of the same phase, which are wound around the teeth of the stator, form a group. It is possible for each group to occur exactly once.

In another embodiment, the stator winding has each group of coils at least twice. This means, for example, that two groups of two adjacent coils of the same phase are provided. For example, this results in the coil sequence +U, +U, −V, −V, +W, +W, −U, −U, +V, +V, −W, −W, where U, V, W denote the electrical phases and + or − the winding direction of the coils.

In alternative embodiments, at least two groups with three or more adjacent coils of the same phase can be provided.

In one embodiment, at least two groups with a different number of neighboring coils can be provided. For example, one group comprises two adjacent coils of the same phase and another group comprises three adjacent coils of the same phase.

In one embodiment, the stator teeth are alternately wound and unwound along the circumference of the stator. This means that only conductors from one coil are inserted in each slot, not from two adjacent coils.

The stator teeth are preferably distributed symmetrically along the circumference of the stator.

In another embodiment, an electrical machine is provided with a stator as described above and with a rotor.

The rotor can, for example, be designed as a PM rotor, i.e. a rotor with permanent magnets. These can be distributed around the circumference of the rotor along the air gap.

Further details and embodiments of the proposed principle are shown below in several embodiment examples by means of drawings. These show:

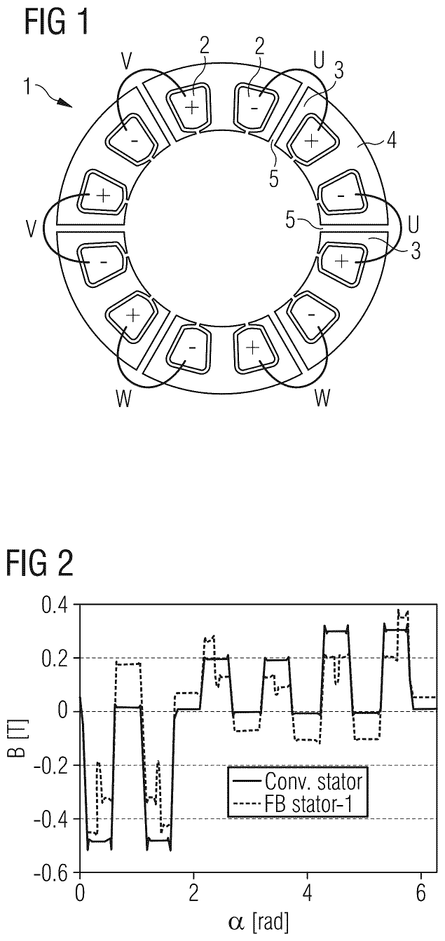

FIG. 1 shows an example of a stator for an electrical machine based on the proposed principle,

FIG. 2 is a diagram of the flux density distribution for FIG. 1,

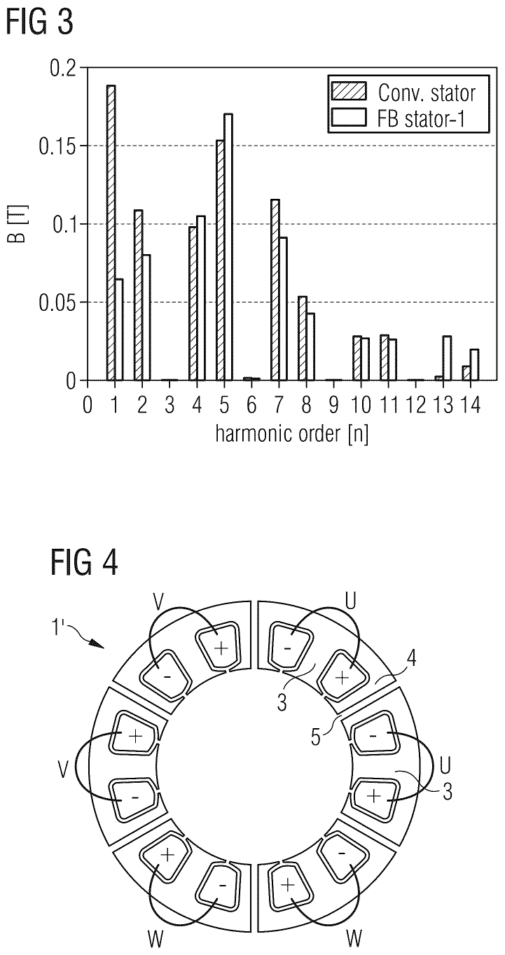

FIG. 3 is a diagram of the harmonic components of FIG. 1,

FIG. 4 shows another example of a stator for an electrical machine based on the proposed principle,

FIG. 5 is a diagram of the flux density distribution for FIG. 4,

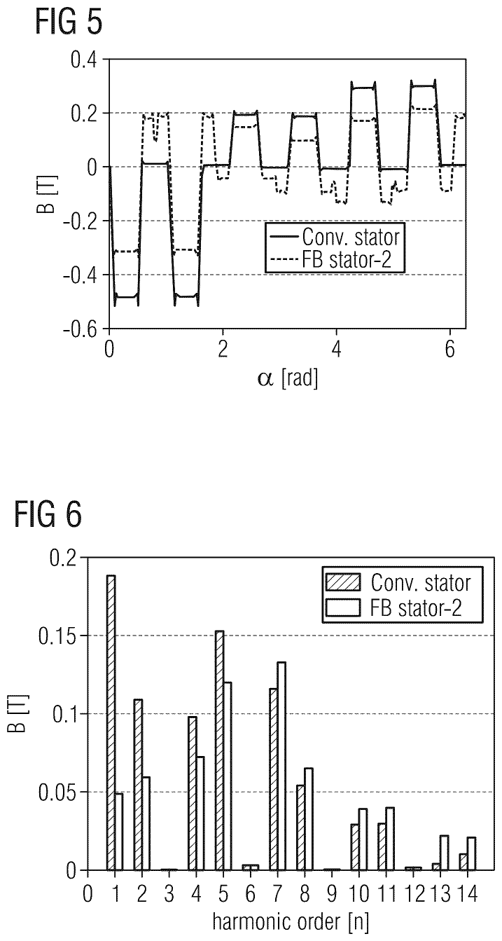

FIG. 6 is a diagram of the harmonic components of FIG. 4,

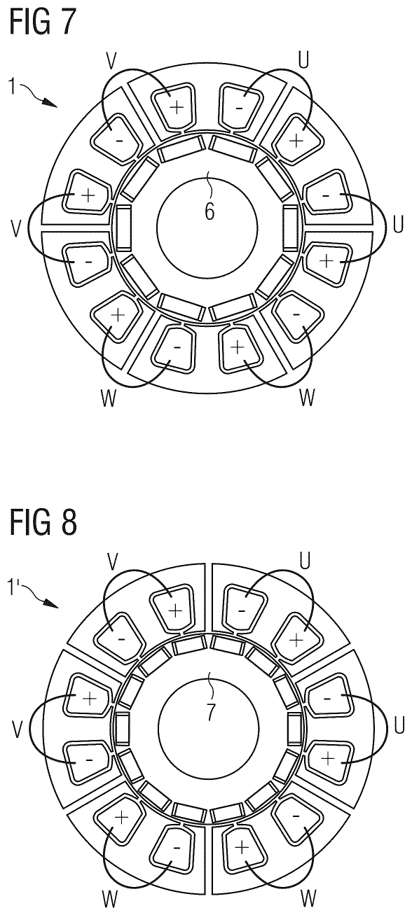

FIG. 7 is an example of an electrical machine based on the proposed principle,

FIG. 8 shows another example of an electrical machine based on the proposed principle,

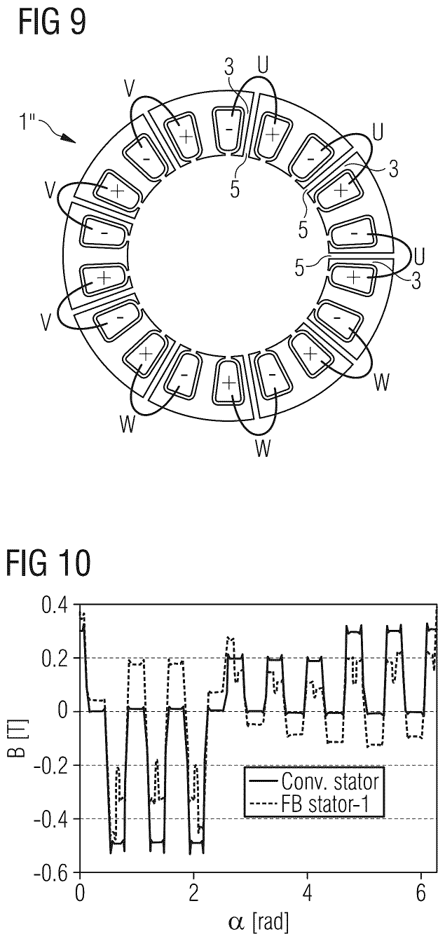

FIG. 9 shows a further example of a stator for an electrical machine based on the proposed principle,

FIG. 10 is a diagram of the flux density distribution for FIG. 9,

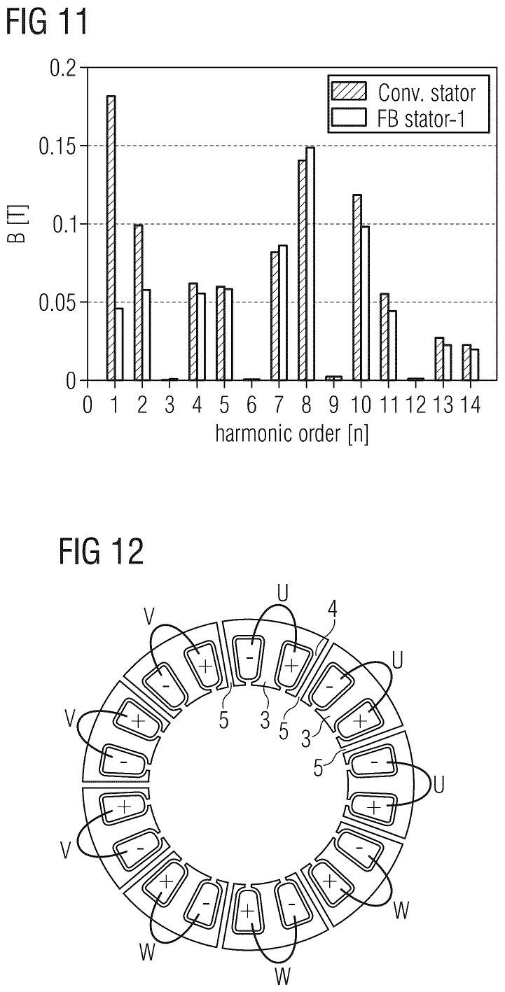

FIG. 11 is a diagram of the harmonic components of FIG. 9,

FIG. 12 is another example of a stator for an electrical machine based on the proposed principle,

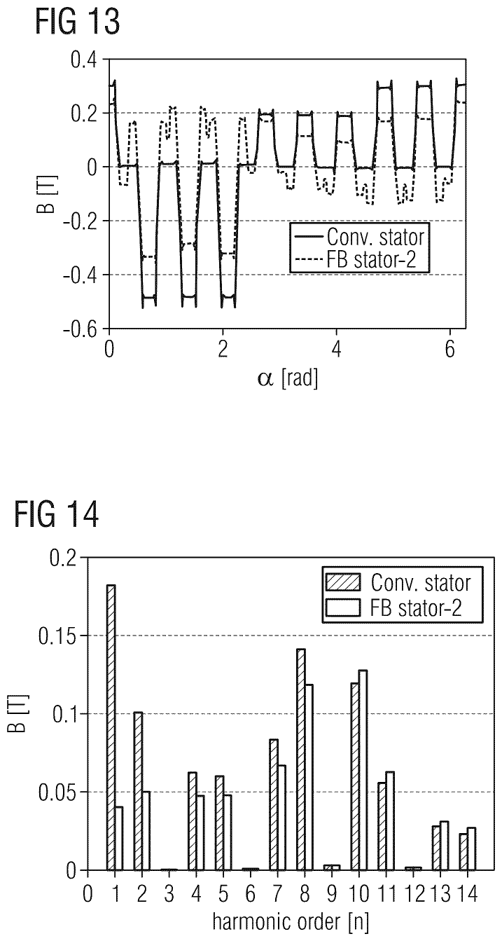

FIG. 13 is a diagram of the flux density distribution for FIG. 12,

FIG. 14 is a diagram of the harmonic components of FIG. 12,

FIG. 15 shows another example of an electrical machine based on the proposed principle,

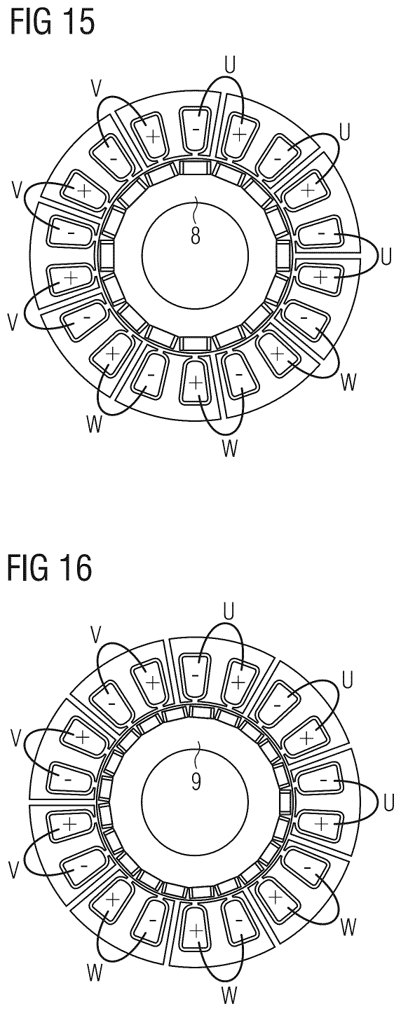

FIG. 16 shows another example of an electrical machine based on the proposed principle,

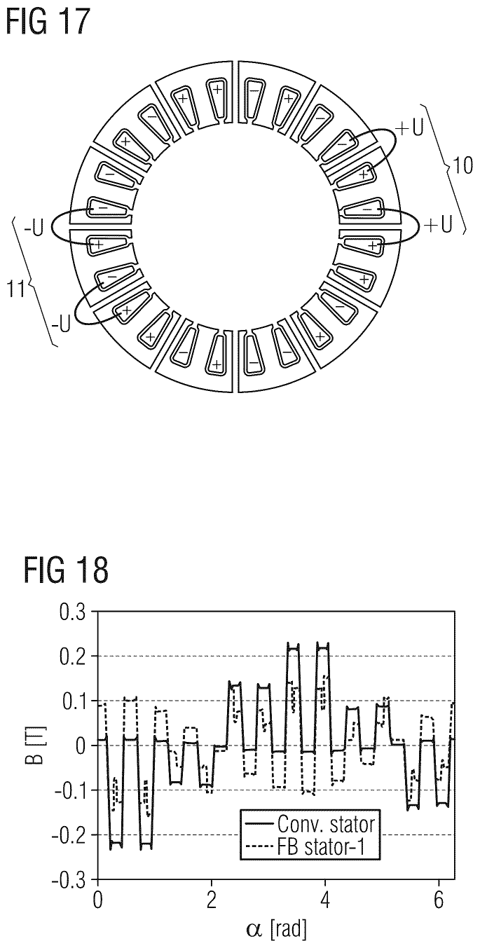

FIG. 17 shows another example of a stator for an electrical machine based on the proposed principle,

FIG. 18 is a diagram of the flux density distribution for FIG. 17,

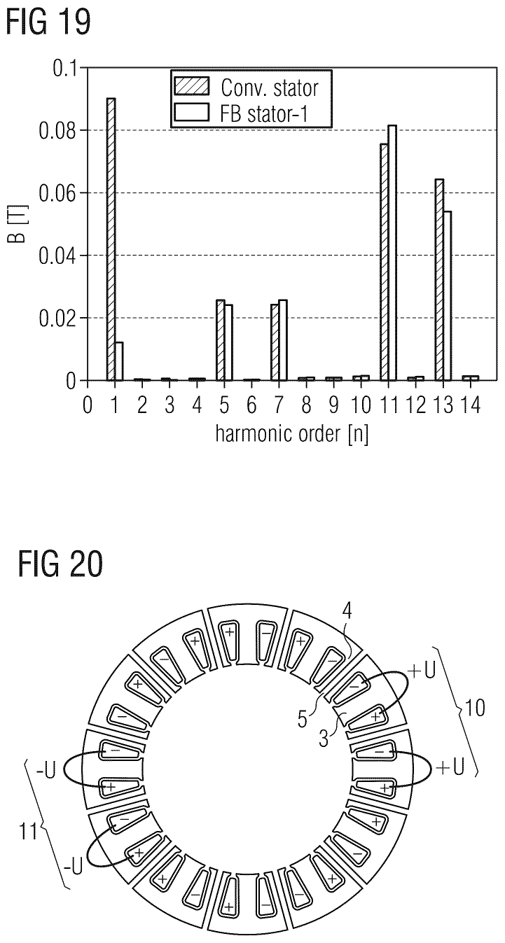

FIG. 19 is a diagram of the harmonic components of FIG. 17,

FIG. 20 shows another example of a stator for an electrical machine based on the proposed principle,

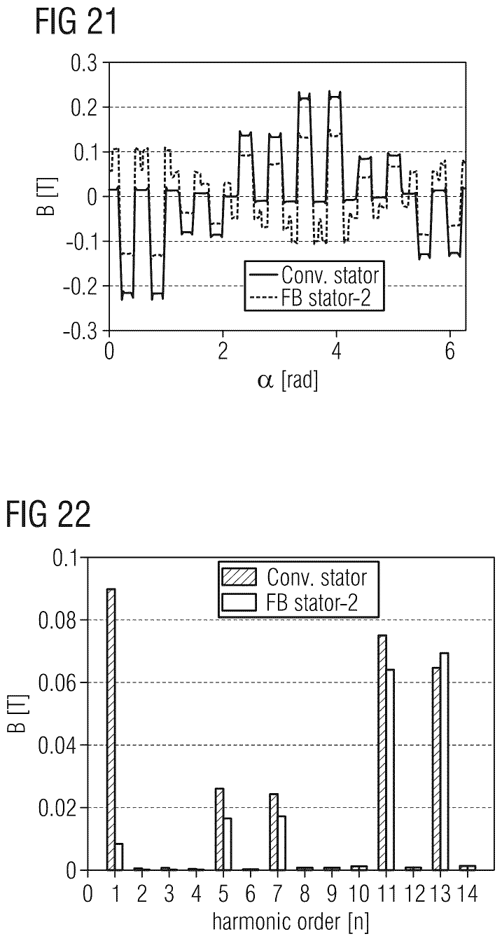

FIG. 21 is a diagram of the flux density distribution for FIG. 20,

FIG. 22 is a diagram of the harmonic components of FIG. 20,

FIG. 23 shows another example of an electrical machine based on the proposed principle,

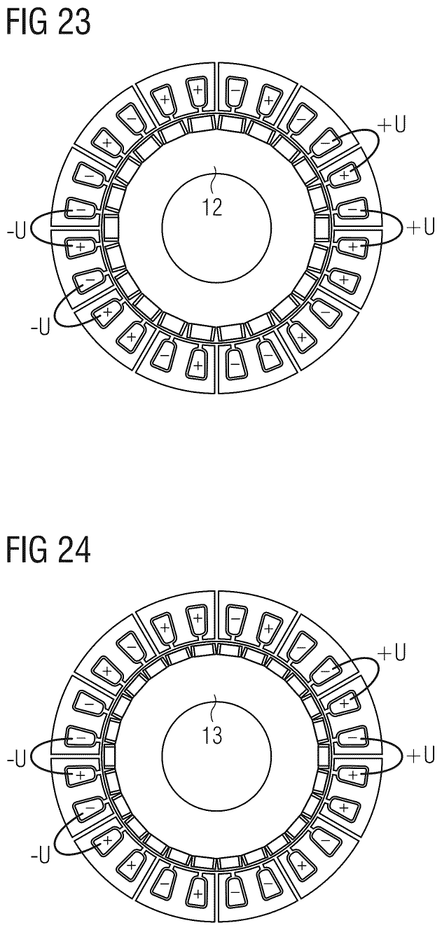

FIG. 24 shows another example of an electrical machine based on the proposed principle,

FIG. 25 shows another example of a stator for an electrical machine based on the proposed principle,

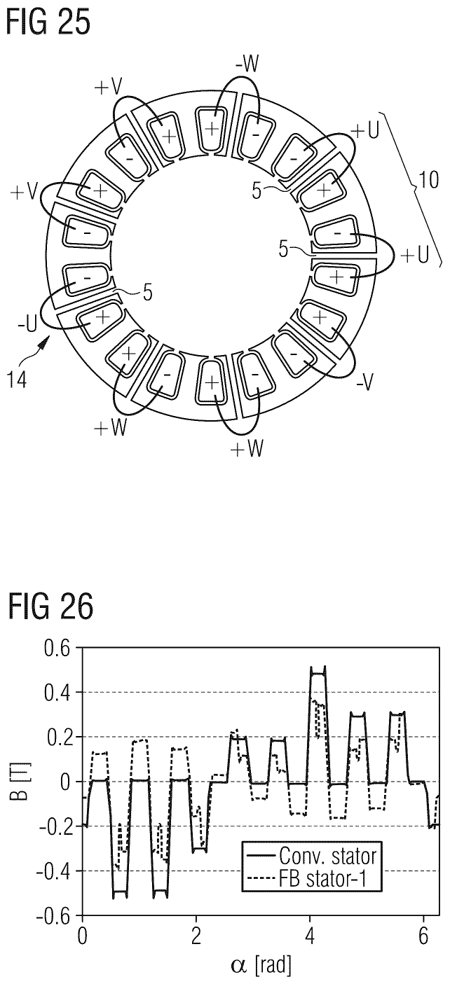

FIG. 26 is a diagram of the flux density distribution for FIG. 25,

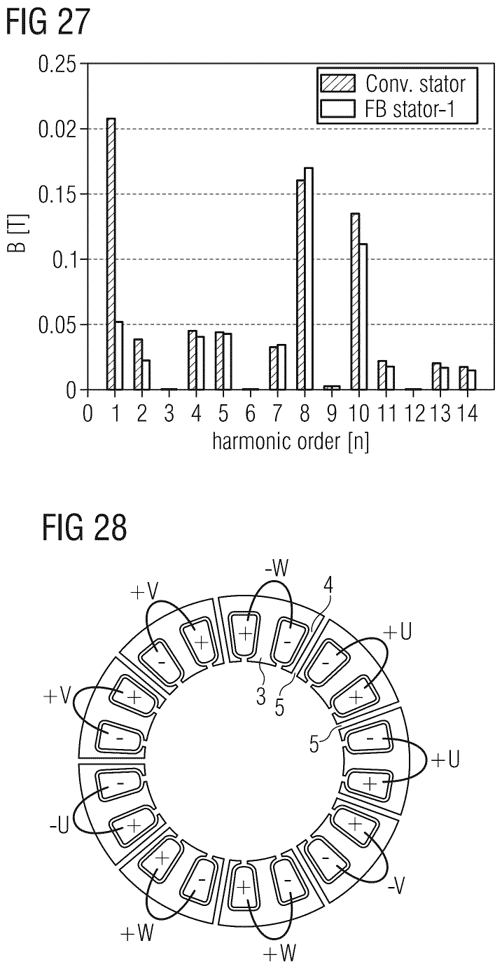

FIG. 27 is a diagram of the harmonic components of FIG. 25,

FIG. 28 shows another example of a stator for an electrical machine based on the proposed principle,

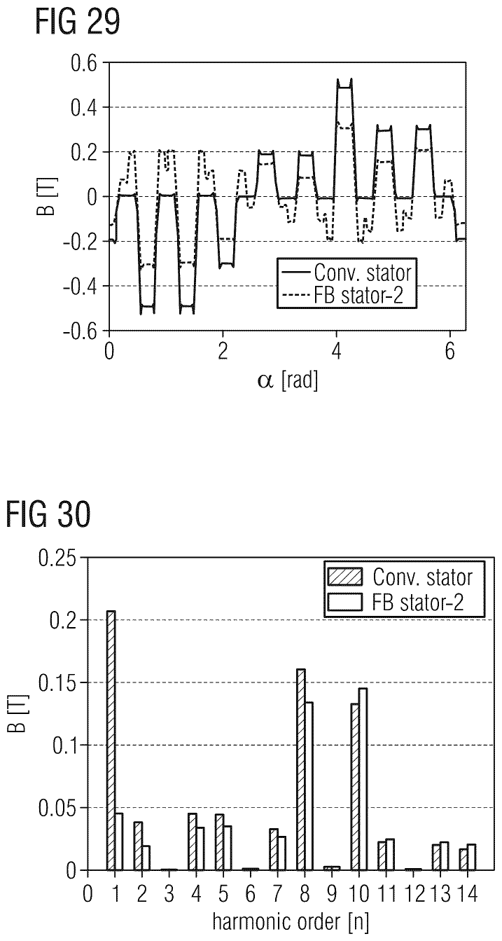

FIG. 29 is a diagram of the flux density distribution for FIG. 28,

FIG. 30 is a diagram of the harmonic components of FIG. 28,

FIG. 31 a further example of an electrical machine according to the proposed principle and

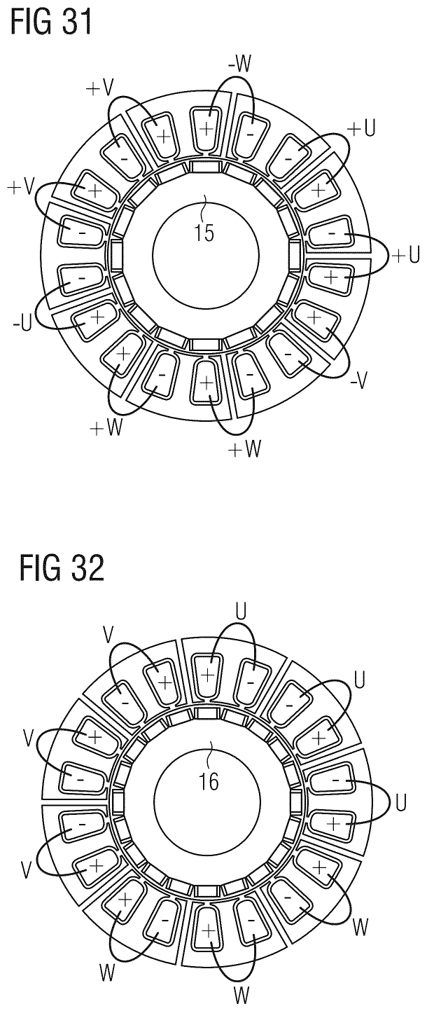

FIG. 32 is another example of an electrical machine based on the proposed principle.

FIG. 1 shows a first example of a stator for an electrical machine based on the proposed principle.

The stator 1 comprises a total of 12 grooves 2, which are distributed along the circumference and extend essentially in a straight line in the axial direction of the stator. Stator teeth 3, 4 are formed between the slots. Coils of the same electrical phase U, V, W are arranged adjacent to each other and wound around respective teeth 3. At least one unwound tooth 4 is provided between the adjacent coils of the same electrical phase U, V, W. The teeth 3 wound with adjacent coils of the same electrical phase each have a recess 5, which extends essentially in the radial direction and is arranged in the tooth region of the wound tooth 3.

In this case, the recess runs completely through the stator 1 in a radial direction, i.e. from the inside of the air gap through to the yoke on the opposite side of the stator in a radial direction.

The recess forms a mechanical barrier to reduce the fundamental waves of the magnetic flux, as explained in more detail in the following figures.

The winding shown in FIG. 1 is a three-phase single-layer winding of the FSCW type mentioned at the beginning. The coils of the winding are each tooth-concentrated, i.e. each coil is wound around exactly one tooth 3.

FIG. 2 shows a comparison of the flux density in the air gap for the design example of an electrical machine with a stator as shown in FIG. 1. The stator as shown in FIG. 1 is shown here with a dashed line in comparison to a conventional stator without the recesses 5 acting as a mechanical barrier, which is shown here with a solid line. The magnetic field B is plotted in Tesla over the angle in Rad, i.e. from 0 to 2 Pi over the circumference.

FIG. 3 also shows a comparison of an electrical machine according to FIG. 1 with a conventional machine without the recesses 5 acting as a mechanical flux barrier, whereby the harmonic components of the flux density distribution are shown in FIG. 3. It can be seen that the working wave, in this case the fifth harmonic, is amplified according to the proposed principle. It is also very clear that the fundamental waves, namely the first order harmonic, is very significantly reduced from just under 0.2 Tesla to approximately 0.06 Tesla.

FIG. 4 shows another embodiment according to the proposed principle, which is a modification of the embodiment in FIG. 1. Insofar as the two designs are similar, the description is not repeated. In contrast to FIG. 1, in FIG. 4 the recesses 5 are not provided in the area of the wound teeth 3 of the stator 1′, but in the unwound tooth 4, which is provided between the wound teeth 3.

The design shown in FIG. 4 has similar advantages to the design shown in FIG. 1, which in turn become clear from the comparative illustrations between the design shown in FIG. 4 and a conventional stator without recesses 5.

FIG. 5 again shows a comparison of the flux density in the air gap, while FIG. 6 visualizes a comparison of the harmonic components of the flux density distribution in the air gap. It can be seen that the working wave, namely the seventh harmonic, is amplified here due to the arrangement of the recesses in the unwound tooth. The reduction of the fundamental waves is even more pronounced here, from just under 0.2 Tesla to around 0.05 Tesla.

FIG. 7 shows the stator from FIG. 1 and also a rotor 6. As mentioned in FIG. 1, the fifth harmonic is used as the working shaft, so the rotor here has ten permanent magnets as magnetic poles. The number of pole pairs of rotor 6 therefore corresponds to the order of the working shaft.

By analogy, FIG. 8 shows the stator of FIG. 4 and additionally a rotor 7, which comprises 14 permanent magnets and thus forms seven magnetic pole pairs, which here also corresponds to the order of the working wave of the magnetomotive force.

In modifications of the designs of electrical machines according to FIGS. 7 and 8, it is of course possible to provide integer multiples of the number of teeth of the stator and the poles of the rotor. In FIG. 7, for example, a machine with 24 teeth and 20 poles, 36 teeth and 30 poles and so on can alternatively be provided.

Similarly, in a modification of FIG. 8, instead of a machine with 12 teeth and 14 poles, machines with 24 teeth and 28 poles, 36 teeth and 42 poles and so on can also be provided. This results in machines with a higher number of pole pairs.

In another embodiment, shown in FIG. 9, the stator 1″ is designed in such a way that not only two coils of the same electrical phase are arranged adjacent to each other and wound around respective teeth, but three. Accordingly, there are three neighboring coils of phase U, three neighboring coils of phase W and three neighboring coils of phase V. Here too, recesses 5 are arranged in each of the wound teeth 3.

FIGS. 10 and 11 describe the flux density in the air gap. In detail, FIG. 10 shows the distribution of the flux density in the air gap over the circumference of 2 Pi, while FIG. 11 shows the harmonic components of the flux density distribution. In each case, the machine with the stator according to FIG. 9 is described with a dashed line or unfilled columns, while a machine with a conventional stator without recesses in the tooth area is described with a solid line or filled columns.

It can be seen that the eighth harmonic of the flux density distribution is used as the working wave. This is amplified by the recesses. Other harmonics, in particular the fundamental waves, are significantly reduced.

FIG. 12 shows another embodiment according to the proposed principle, in which, as in FIG. 9, three coils of the same electrical phase are arranged adjacent to each other and wound around respective teeth of the stator, but analogous to FIG. 4, the recesses are provided here in the unwound teeth and not in the wound teeth as in FIG. 9. Since the design of FIG. 12 otherwise corresponds to the design of FIG. 9, its description is not repeated here.

FIGS. 13 and 14 again show the already familiar diagrams of the flux density characteristics for the design according to FIG. 12. The distribution of the harmonics of the flux density distribution in FIG. 14 clearly shows that in the present example the tenth harmonic is amplified and used as a working wave.

FIG. 15 shows the stator of FIG. 9 as well as a rotor 8, which here has 16 poles and thus a number of pole pairs of eight, which corresponds to the working shaft of this design.

Accordingly, FIG. 16 shows an electrical machine with the stator of FIG. 12 and a rotor 9, which has a total of 20 magnetic poles that are distributed along the air gap, again along the circumference of the rotor, with north poles and south poles alternating as in the aforementioned rotors. The 20 magnetic poles of the rotor form a pole pair number of ten, which in turn corresponds exactly to the working shaft.

FIG. 17 shows a further example of a stator for an electrical machine based on the proposed principle. As in FIG. 1, recesses 5 are provided in the area of the wound teeth 3 in this embodiment example.

In all previous embodiments, there was only exactly one group of adjacent coils of this same phase per electrical phase. In the embodiment shown in FIG. 17, however, there are two groups or zones of adjacent coils of the same phase. FIG. 17 shows two adjacent coils of the electrical phase U in a first group 10 in the right half of the figure, and two further adjacent coils of this phase U in another group 11 in the left half of the figure, i.e. diametrically opposite. In this configuration, the stator has 24 slots and the first and second groups 10, 11 of the neighboring coils of phase U are electrically out of phase with each other by 180° and have opposite winding polarities, in other words an opposite winding sense.

FIG. 18 again shows the flux density distribution in comparison with a conventional stator of the same design, in which only the recesses 5 are missing.

FIG. 19, which describes the higher harmonics of the flux density distribution in the air gap, clearly shows that the 11th harmonic, which is used here as the working wave, is amplified. The reduction of the fundamental waves by a factor of almost 10 is particularly clear in this design example.

FIG. 20 shows another embodiment in modification of the embodiment according to FIG. 17, in which the recesses 5 are not present in the wound teeth, but rather in the unwound teeth 4. Otherwise, the embodiment according to FIG. 20 corresponds to that of FIG. 17 and is not described again here.

FIGS. 21 and 22 again show the flux density distribution according to FIG. 21 and the distribution of the harmonic components in FIG. 22 in the design according to FIG. 20 in comparison to a conventional stator without the recesses 5. FIG. 22 clearly shows that the 13th harmonic is amplified, which is also used here as the working wave.

FIG. 23 shows an example of an electrical machine with the stator shown in FIG. 17 and a rotor 12 along the circumference of which a total of 22 magnets in the form of permanent magnets are distributed to form the pole pair number 11, which corresponds to the working shaft of this machine.

Accordingly, FIG. 24 shows an example of an electrical machine with the stator shown in FIG. 20 and a rotor 13, which comprises a total of 26 permanent magnets distributed along its circumference, which form the pole pair number 13. This corresponds to the 13th harmonic in this machine, which serves here as the working shaft.

FIG. 25 shows a further example of a stator for an electrical machine according to the proposed principle. As in the previous examples, more than one group of adjacent coils of the same phase are provided in the stator. However, in contrast to the two previous embodiments, these two groups do not have the same number of coils adjacent to the same phase, but a different number. Thus, FIG. 25 again shows the first group 10 with two coils of the electrical phase U, which are wound adjacent to each other around corresponding teeth of the stator. In relation to the axis opposite, a further group of coils is arranged, which however only comprises a single coil in this embodiment example, which is provided here with reference sign 14. This has an opposite winding direction. This second group is arranged between the groups each comprising two coils of phase V and W.

The number of grooves Q_{S} is calculated using the formula

$${Q}_{S} = 2 \cdot m \cdot z \cdot ( {n}_{c 11} + {n}_{c 12} )$$

where m is the number of electrical phases, z is the number of phase groups per phase, non is the number of coils per group and n_{c12} is the number of coils in a further group. In the example shown in FIG. 25, the stator therefore has 18 slots.

Recesses 5 are provided in all wound teeth in this example.

FIGS. 26 and 27 again describe the properties and mode of operation of the recesses in comparison with a stator without these recesses, firstly on the basis of the flux density distribution shown in FIG. 26 and the distribution of the harmonic components shown in FIG. 27. FIG. 27 clearly shows that the eighth harmonic is used here as the working wave and that this is also effectively amplified according to the proposed principle.

FIG. 28 shows a modification of the design shown in FIG. 25, which largely corresponds to it and in which only the recesses are not provided in the area of the wound teeth 3, but in the area of the unwound teeth 4. Insofar as the figures correspond, the description is not repeated.

FIGS. 29 and 30 again show the performance of the proposed principle based on the flux density distribution in the air gap according to FIG. 29 and the distribution of the harmonic components according to FIG. 30, in each case in comparison to a conventional stator without recesses 5. It is obvious that the 10th harmonic is amplified and accordingly this is also used as a working wave.

FIG. 31 shows an electrical machine with a stator as shown in FIG. 25 and a rotor, which has 16 permanent magnets and is provided with reference number 15.

FIG. 32 shows an electrical machine with a stator as shown in FIG. 28 and a rotor 16, which has 20 magnetic poles and thus 10 pole pairs, which is adapted to the 10th harmonic of this machine, which is used as the working shaft.

Here too, as in the previous examples, a machine type with a higher number of pole pairs can be achieved by multiplying the number of teeth in the stator and the number of poles in the rotor by whole lines, for example a machine with 36 slots and 32 poles or 54 slots and 48 poles and so on for FIG. 31.

For FIG. 32, this means that the machine can have 36 grooves and 40 poles or 54 grooves and 60 poles instead of the 18 grooves and 20 poles shown.

### LIST OF REFERENCE SYMBOLS

1 Stator
1′ Stator
1″ Stator
2 groove
3 tooth, wound
4 tooth, unwound
5 Recess
6 Rotor
7 Rotor
8 Rotor
9 Rotor
10 Coil group
11 Coil group
12 Rotor
13 Rotor
14 Coil group
15 Rotor
16 Rotor
U electrical phase
V electrical phase
W electrical phase

1. Stator for an electrical machine, the stator comprising:
several stator teeth (3, 4), which are distributed along the circumference of the stator (1) and between which grooves (2) are formed in each case,
wherein coils of the same electrical phase (U, V, W) are arranged adjacent to each other and wound around respective teeth (3),
wherein at least one unwound tooth (4) is provided between the adjacent coils of the same electrical phase,
in which the teeth (3) wound with adjacent coils of the same electrical phase each have a recess (5) which extends substantially in the radial direction and is arranged in the tooth region, or in which the at least one unwound tooth (4) each has a recess which extends substantially in the radial direction and is arranged in the tooth region.

2. Stator according to claim 1, in which
in addition to the recess (5) in the unwound tooth (4), which is arranged between teeth with coils of the same phase,
a recess is provided in an unwound tooth, which is arranged between teeth with coils of different phases.

3. Stator according to claim 1 or 2, in which
the recess (5) forms a mechanical barrier to reduce of the fundamental waves of the magnetic flux.

4. Stator according to one of the preceding claims, in which the distance between the recesses (5) corresponds to twice the distance between the grooves.

5. Stator according to one of the preceding claims, in which a higher harmonic of the magnetomotive force different from the fundamental waves is used as the working wave.

6. Stator according to one of the preceding claims, in which a multiphase single-layer winding comprising the aforementioned coils is inserted into the grooves (2).

7. Stator according to one of the preceding claims, in which not only two coils of the same phase are arranged adjacent and wound around teeth (3) of the stator, but three.

8. Stator according to one of the preceding claims, wherein not only two coils of the same phase are arranged adjacent and wound around teeth (3) of the stator, but more than three.

9. Stator according to one of the preceding claims, in which at least two groups (10, 11) with two, three or more adjacent coils of the same phase are provided.

10. Stator according to one of the preceding claims, wherein at least two groups (10, 14) with different numbers of adjacent coils are provided.

11. Stator according to one of the preceding claims, wherein the stator teeth (3, 4) are alternately wound and unwound along the circumference of the stator.

12. Stator according to one of the preceding claims, wherein the stator teeth (3, 4) are distributed symmetrically along the circumference of the stator.

13. Electrical machine with a stator according to one of claims 1 to 11 and with a rotor (6).

14. Electrical machine according to claim 11,
in which the rotor (6) is designed as a rotor with permanent magnets.
